(19) United States
(12) Patent Application Publication
(10) Pub. No.: US 2026/0298737 A1
(43) Pub. Date: Oct. 1, 2026

(54) STRAIN GAUGE, METHOD FOR PRODUCING STRAIN GAUGE, AND SENSOR DEVICE

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 19/545,781

(22) Filed: Feb. 20, 2026

(30) Foreign Application Priority Data
Mar. 31, 2025 (JP) 2025-059056

(51) Int. Cl. G01L 1/22

(52) U.S. Cl. CPC G01L 1/2287; G01L 1/2231; G01L 1/225

(57) ABSTRACT

Provided is a sensor device that does not require a long time to mount a plurality of strain-sensitive elements onto a strain body and that hardly causes variation in arrangement of the strain-sensitive elements thus mounted. The strain gauge includes: a film; a wiring formed on one main surface of the film by film deposition; a strain-sensitive element formed on the one main surface of the film by film deposition, the strain-sensitive element being connected with the wiring.

### TECHNICAL FIELD

This Nonprovisional application claims priority under 35 U.S.C. § 119 on Patent Application No. 2025-059056 filed in Japan on Mar. 31, 2025, the entire contents of which are hereby incorporated by reference.

The present invention relates to a film-type strain gauge and a method for producing the strain gauge. The present invention further relates to a sensor device including such a strain gauge.

### BACKGROUND ART

A sensor device that detects, by using a strain gauge adhered to the strain body, force and/or torque acting on a strain body is widely used. As the strain gauge, a film-type strain gauge that includes a film and a single pair of strain-sensitive elements formed on one main surface of the film is often used. A document that discloses the film-type strain gauge is Patent Literature 1, for example.

### CITATION LIST

### Patent Literature

[Patent Literature 1]

Japanese Patent Application Publication, Tokukai, No. 2022-62311

### SUMMARY OF INVENTION

### Technical Problem

In a sensor device, it is typically necessary to mount two or more pairs of strain-sensitive elements onto a strain body. Therefore, in order to produce the sensor device, it has been necessary to adhere a plurality of film-type strain gauges, each including a single pair of strain-sensitive elements, onto the strain body individually. Consequently, the process of mounting the two or more pairs of strain-sensitive elements onto the strain body requires a long time, and variation is likely to occur in arrangement of the two or more pairs of strain-sensitive elements, disadvantageously. Moreover, in order to connect the two or more pairs of strain-sensitive elements to an amplifier or the like, it has been necessary to individually connect (e.g., via soldering) wirings to the plurality of film-type strain gauges, each including a single pair of strain-sensitive elements. Consequently, the process of connecting the plurality of film-type strain gauges to the amplifier or the like requires a long time, and arrangement of the connected wirings is likely to become complicated, disadvantageously.

An aspect of the present invention was made in light of the above-mentioned problems, and has an object to provide a sensor device that does not require a long time to mount two or more pairs of strain-sensitive elements onto a strain body and that hardly causes variation in arrangement of the two or more pairs of strain-sensitive elements thus mounted.

### Solution to Problem

A strain gauge included in a sensor device in accordance with an aspect of the present invention includes: a film; a wiring formed on one main surface of the film by film deposition; and two or more pairs of strain-sensitive elements formed on the one main surface of the film by film deposition, the two or more pairs of strain-sensitive elements being connected with the wiring.

A method, in accordance with an aspect of the present invention, for producing a strain gauge, includes the steps of: forming a wiring on one main surface of a film by film deposition; and forming two or more pairs of strain-sensitive elements on the one main surface of the film by film deposition, the two or more pairs of strain-sensitive elements being connected with the wiring.

### Advantageous Effects of Invention

In accordance with an aspect of the present invention, it is possible to mount two or more pairs of strain-sensitive elements onto a strain body merely by adhering, to the strain body, a single strain gauge having the two or more pairs of strain-sensitive elements formed thereon by film deposition. Consequently, it is possible to provide a sensor device that does not require a long time to mount two or more pairs of strain-sensitive elements onto a strain body and that hardly causes variation in arrangement of the two or more pairs of strain-sensitive elements thus mounted.

### BRIEF DESCRIPTION OF DRAWINGS

FIG. 1 is a plan view illustrating a front side of a strain gauge in accordance with a first embodiment of the present invention.

FIG. 2 is a plan view illustrating a back side of the strain gauge shown in FIG. 1.

FIG. 3 is a cross-sectional view illustrating a cross section of the strain gauge shown in FIG. 1.

FIG. 4 is a plan view illustrating a front side of a strain gauge in accordance with a second embodiment of the present invention.

FIG. 5 is a plan view illustrating a back side of the strain gauge shown in FIG. 4.

FIG. 6 is a cross-sectional view illustrating a cross section of the strain gauge shown in FIG. 4.

FIG. 7 is a perspective view illustrating a sensor device including the strain gauge shown in FIGS. 1 to 3.

### DESCRIPTION OF EMBODIMENTS

### First Embodiment

### Configuration of Strain Gauge

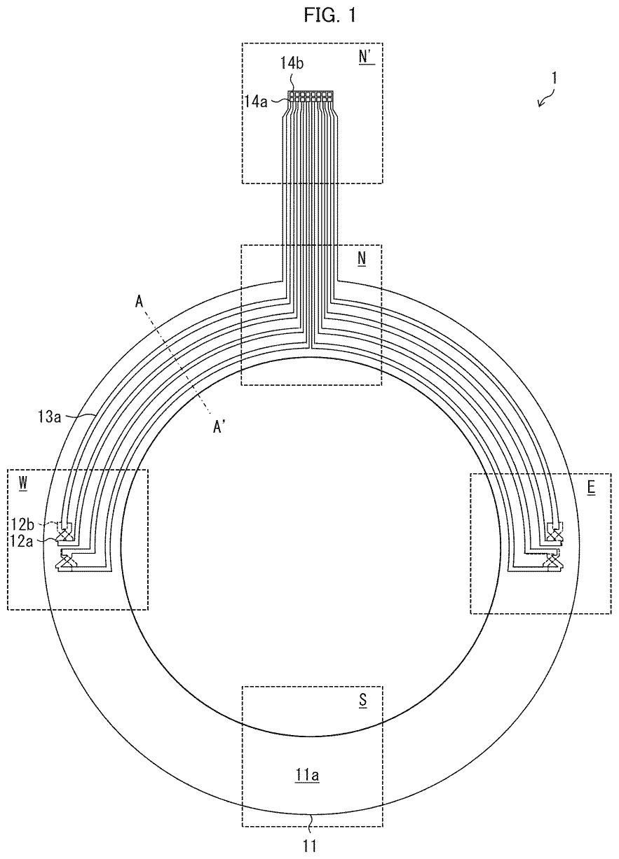

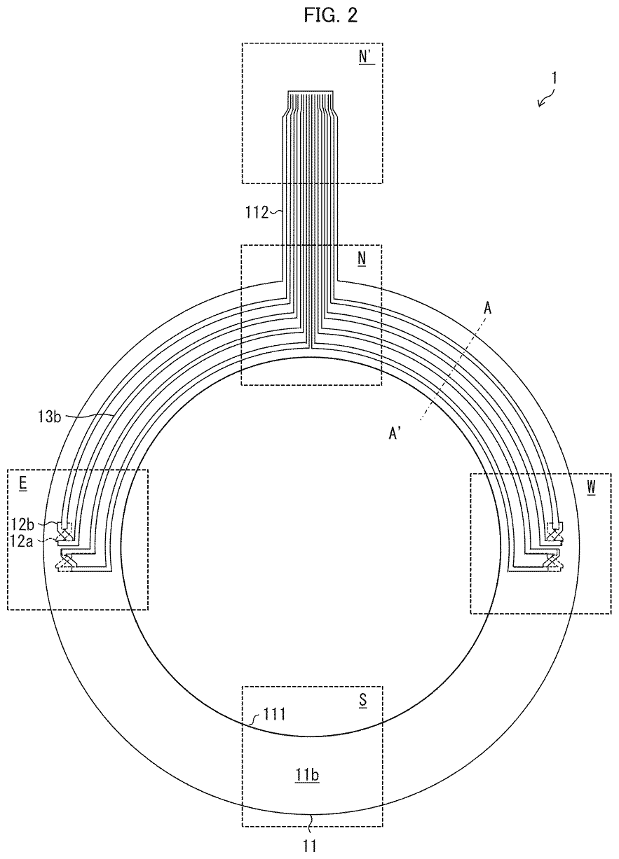

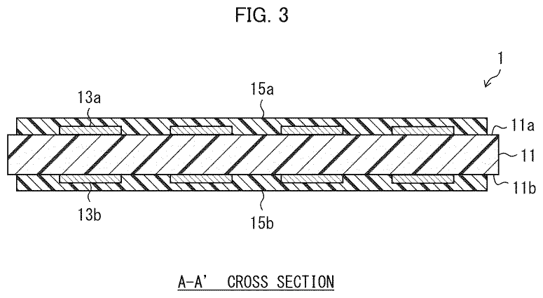

The following will describe, with reference to FIGS. 1 to 3, a configuration of a strain gauge 1 in accordance with a first embodiment of the present invention. FIG. 1 is a plan view illustrating a front side of the strain gauge 1. FIG. 2 is a plan view illustrating a back side of the strain gauge 1. FIG. 3 is a cross-sectional view illustrating an A-A′ cross section of the strain gauge 1.

The strain gauge 1 includes a film 11, strain-sensitive elements 12a and 12b, wirings 13a and 13b, electrode pads 14a and 14b, and protective films 15a and 15b. Note that the protective films 15a and 15b are not illustrated in FIGS. 1 and 2.

The film 11 is a film-shaped insulator. A polyimide film is used as the film 11. However, this is not limitative. The film 11 may be made of any material.

In the present embodiment, the film 11 is constituted by an annular part 111 and a band-shaped part 112 extending outwardly from an outer periphery of the annular part 111. In the following description, when the strain gauge 1 is viewed in a plan from a front side, a direction in which the band-shaped part 112 extends as viewed from a center of the annular part 111 is defined as a 0 o'clock direction. When the strain gauge 1 is viewed in a plan from the front side, a region of the annular part 111 located in the 0 o'clock direction will be referred to as a “region N,” a region of the annular part 111 located in a 3 o'clock direction will be referred to as a “region E,” a region of the annular part 111 located in a 6 o'clock direction will be referred to as a “region S,” and a region of the annular part 111 located in a 9 o'clock direction will be referred to as a “region W”. Meanwhile, a region of the band-shaped part 112 located at an end opposite to an end closer to the annular part 111 will be referred to as a “region N′”.

As shown in FIG. 1, a front surface 11a, which is one main surface of the film 11, is provided with two or more pairs of (in the present embodiment, four pairs, i.e., eight in total) strain-sensitive elements 12a, the wirings 13a, the electrode pads 14a, and the electrode pad 14b which are formed thereon by film deposition. One end of each wiring 13a is connected with its corresponding strain-sensitive element 12a, and the other end of the wiring 13a is connected with its corresponding electrode pad 14a. Each strain-sensitive element 12a is connected with two wirings 13a. Thus, on the front surface 11a of the film 11, the wirings 13a and the electrode pads 14a whose numbers are twice the number of the strain-sensitive elements 12a are formed by film deposition. Each strain-sensitive element 12a is a band-shaped conductor having a resistance which is likely to change according to strain. A material of the strain-sensitive element 12a may be a chromium nitride, for example. However, this is not limitative. Each of the wirings 13a is a band-shaped conductor having a resistance which hardly changes according to strain. Each of the electrode pads 14a and 14b is a quadrangular conductor having a resistance which hardly changes according to strain. Materials of the wirings 13a and the electrode pads 14a and 14b may be copper, for example. However, this is not limitative.

In the present embodiment, the front surface 11a of the film 11 is provided with four strain-sensitive elements 12a formed thereon by film deposition. Of the four strain-sensitive elements 12a, two strain-sensitive elements 12a are arranged in the region E, and the remaining two strain-sensitive elements 12a are arranged in the region W. Each of the strain-sensitive elements 12a is connected with two wirings 13a. Thus, the two strain-sensitive elements 12a arranged in the region E are connected with a total of four wirings 13a. These four wirings 13a extend from the region E to the region N through a quarter-arc-shaped path defined in the annular part 111, and further extend from the region N to the region N′ through a linear path defined in the band-shaped part 112. Tip ends of the four wirings 13a are connected with the electrode pads 14a arranged in the region N′. Similarly, the two strain-sensitive elements 12a arranged in the region W are connected with a total of four wirings 13a. These four wirings 13a extend from the region W to the region N through a quarter-arc-shaped path defined in the annular part 111, and further extend from the region N to the region N′ through a linear path defined in the band-shaped part 112. Tip ends of the four wirings 13a are connected with the electrode pads 14a arranged in the region N′.

As shown in FIG. 3, the front surface 11a of the film 11 may be provided with the protective film 15a formed thereon by film deposition, the protective film 15a covering the strain-sensitive elements 12a and the wirings 13a. A material of the protective film 15a may be a silicon dioxide, for example. However, this is not limitative. Note that the protective film 15a is preferably formed by film deposition so as not to cover the electrode pads 14a and 14b.

As shown in FIG. 2, a back surface 11b, which is the other main surface of the film 11, is provided with two or more pairs of (in the present embodiment, four pairs, i.e., eight in total) other strain-sensitive elements 12b and other wirings 13b which are formed thereon by film deposition. One end of each wiring 13b is connected with its corresponding strain-sensitive element 12a, and the other end of the wiring 13b is connected with its corresponding electrode pad 14b, which is formed on the front surface 11a of the film 11 by film deposition via a through-hole provided in the film 11. Each strain-sensitive element 12b is connected with two wirings 13b. Thus, on the back surface 11b of the film 11, the wirings 13b whose number is twice the number of the strain-sensitive elements 12b are formed. Meanwhile, on the front surface 11a of the film 11, the electrode pads 14b whose number is twice the number of the strain-sensitive elements 12b are formed by film deposition. Each strain-sensitive element 12b is a band-shaped conductor having a resistance which is likely to change according to strain. A material of the strain-sensitive element 12b may be a chromium nitride, for example. However, this is not limitative. Each of the wirings 13b is a band-shaped conductor having a resistance which hardly changes according to strain. A material of the wirings 13b may be copper, for example. However, this is not limitative.

In the present embodiment, the back surface 11b of the film 11 is provided with four strain-sensitive elements 12b formed thereon by film deposition. Of the four strain-sensitive elements 12b, two strain-sensitive elements 12b are arranged in the region E, and the remaining two strain-sensitive elements 12b are arranged in the region W of the annular part 111. Each of the strain-sensitive elements 12b is connected with two wirings 13b. Thus, the two strain-sensitive elements 12b arranged in the region E are connected with a total of four wirings 13b. These four wirings 13b extend from the region E to the region N through a quarter-arc-shaped path defined in the annular part 111, and further extend from the region N to the region N′ through a linear path defined in the band-shaped part 112. One tip end of each of the four wirings 13b is connected with its corresponding electrode pad 14b, which is formed on the front surface 11a of the film 11, via a through-hole provided in the film 11. Similarly, the two strain-sensitive elements 12b arranged in the region W are connected with a total of four wirings 13b. These four wirings 13b extend from the region W to the region N through a quarter-arc-shaped path defined in the annular part 111, and further extend from the region N to the region N′ through a linear path defined in the band-shaped part 112. One tip end of each of the four wirings 13b is connected with its corresponding electrode pad 14b, which is formed on the front surface 11a of the film 11, via a through-hole provided in the film 11.

As shown in FIG. 3, the back surface 11b of the film 11 may be provided with another protective film 15b formed thereon by film deposition, the another protective film 15b covering the strain-sensitive elements 12b and the wirings 13b. A material of the another protective film 15b may be a silicon dioxide, for example. However, this is not limitative.

The strain-sensitive elements 12a formed on the front surface 11a of the film 11 by film deposition overlap the other strain-sensitive elements 12b formed on the back surface 11b of the film 11 by film deposition (to be more specific, the strain-sensitive elements 12a and the other strain-sensitive elements 12b intersect with each other and partially overlap each other), when the film 11 is seen in a plan view. The wirings 13a formed on the front surface 11a of the film 11 by film deposition overlap the other wirings 13b formed on the back surface 11b of the film 11 by film deposition (to be more specific, the wirings 13a and the other wirings 13b extend in parallel with each other and partially overlap each other), when the film 11 is seen in a plan view. Accordingly, a combination of the strain-sensitive elements 12a and the wirings 13a formed on the front surface 11a of the film 11 by film deposition and a combination of the strain-sensitive elements 12b and the wirings 13b formed on the back surface 11b of the film 11 by film deposition have equivalent performance. That is, it can be expressed that the strain gauge 1 provides redundancy of a circuit for detecting strain which circuit is made of the combination of the strain-sensitive elements 12a and the wirings 13a.

The present embodiment employs a configuration in which a plurality of sets of the strain-sensitive elements 12a and the wirings 13a are formed on the front surface 11a of the film 11 by film deposition. However, the present invention is not limited to this. That is, a single set of the strain-sensitive element 12a and the wiring 13a may alternatively be formed on the front surface 11a of the film 11 by film deposition.

### Method for Producing Strain Gauge

The above-described strain gauge 1 can be produced by, for example, a production including the following steps.
Step 1: A film 11 is produced by laser cutting a polyimide film into a predetermined shape.
Step 2: On a front surface 11a of the film 11, a copper film functioning as wirings 13a as well as electrode pads 14a and 14b is formed by film deposition.
Step 3: On the front surface 11a of the film 11, a chromium nitride film functioning as strain-sensitive elements 12a is formed by film deposition.
Step 4: On the front surface 11a of the film 11, a silicon dioxide film functioning as a protective film 15a is formed by film deposition.
Step 5: On a back surface 11b of the film 11, a copper film functioning as wirings 13b is formed by film deposition.
Step 6: On the back surface 11b of the film 11, a chromium nitride film functioning as strain-sensitive elements 12b is formed by film deposition.
Step 7: On the back surface 11b of the film 11, a silicon dioxide film functioning as a protective film 15b is formed by film deposition.
Step 8: To the back surface 11b of the film 11, a reinforcement plate that reinforces a tip end of a band-shaped part 112 is adhered.

Through-holes for electrically connecting the electrode pads 14b formed on the front surface 11a of the film 11 by film deposition in step 2 and the wirings 13b formed on the back surface 11b of the film 11 by film deposition in step 5 may be formed in step 1. Alternatively, step 1 may be carried out by using a polyimide film having through-holes having been formed in advance.

### Second Embodiment

### Configuration of Strain Gauge

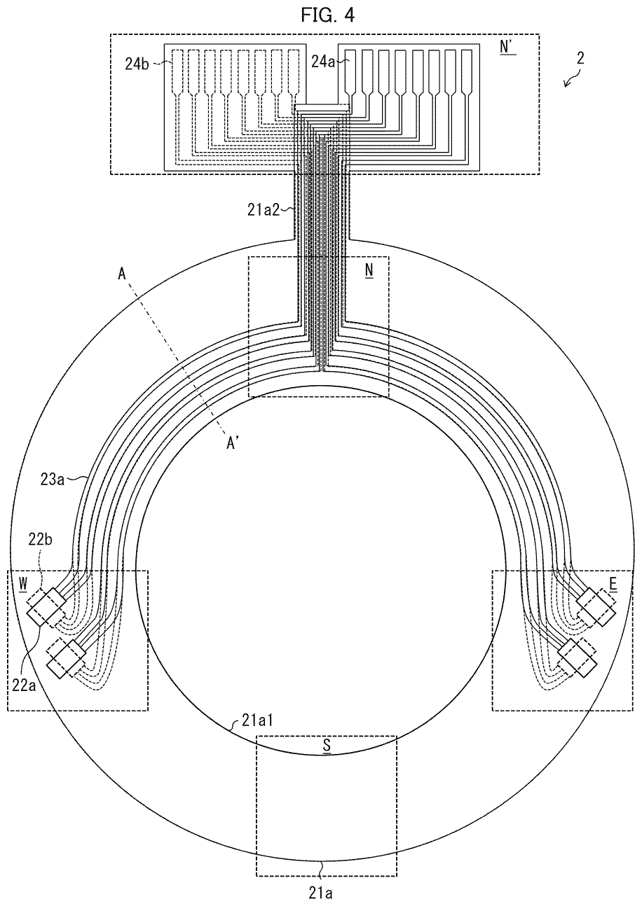

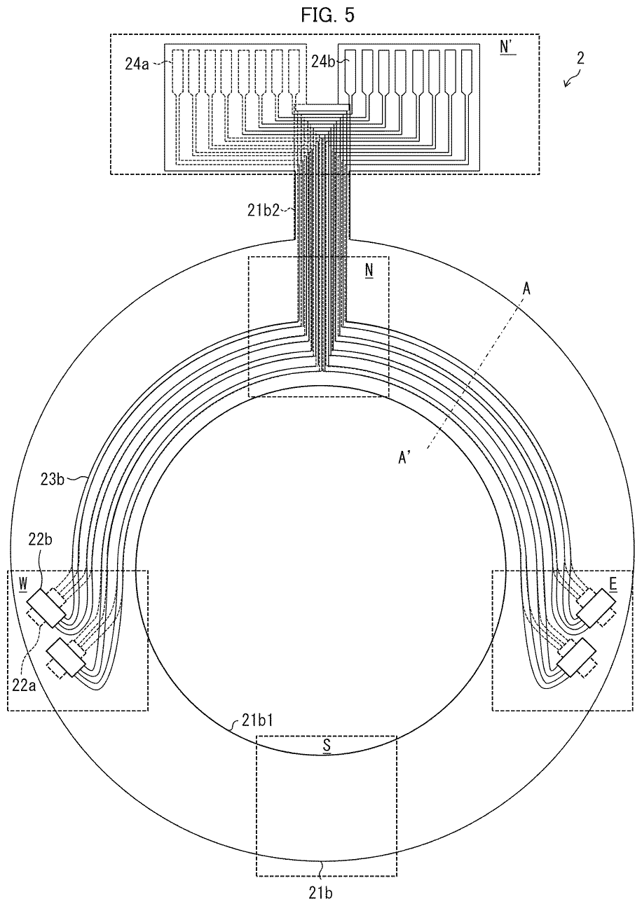

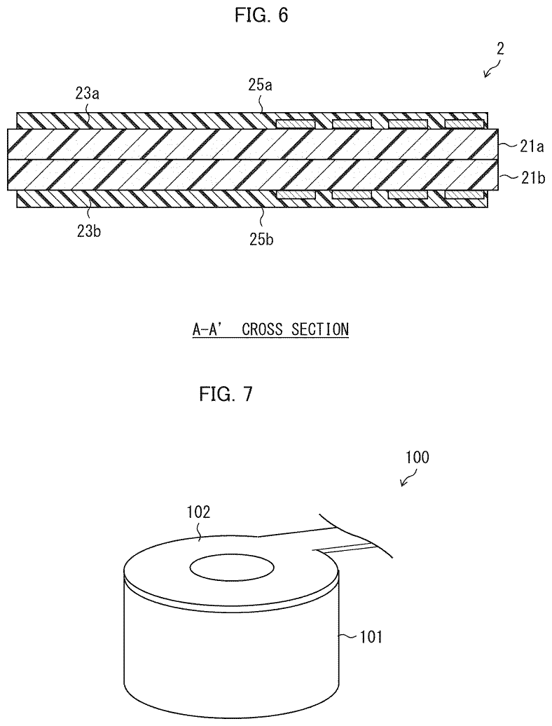

The following will describe, with reference to FIGS. 4 to 6, a configuration of a strain gauge 2 in accordance with a second embodiment of the present invention. FIG. 4 is a plan view illustrating a front side of the strain gauge 2. FIG. 5 is a plan view illustrating a back side of the strain gauge 2. FIG. 6 is a cross-sectional view illustrating an A-A′ cross section of the strain gauge 2.

The strain gauge 2 includes films 21a and 21b, strain-sensitive elements 22a and 22b, wirings 23a and 23b, electrode pads 24a and 24b, and protective films 25a and 25b. Note that the protective films 25a and 25b are not illustrated in FIGS. 4 and 5.

Each of the films 21a and 21b is a film-shaped insulator. As each of the films 21a and 21b, a polyethylene terephthalate (PET) film is used. However, this is not limitative. The films 21a and 21b may be made of any material. The films 21a and 21b are adhered such that the film 21a is disposed closer to a front surface of the strain gauge 2 and the film 21b is disposed closer to a back surface of the strain gauge 2. That is, a back surface of the film 21a and a front surface of the film 21b are adhered to each other, so that a front surface of the film 21a serves as a front surface of the strain gauge 2 and a back surface of the film 21b serves as a back surface of the strain gauge 2.

In the present embodiment, the film 21a is constituted by an annular part 21a1 and a band-shaped part 21a2 extending outwardly from an outer periphery of the annular part 21a1. Similarly, the film 21b is constituted by an annular part 21b1 and a band-shaped part 21b2 extending outwardly from an outer periphery of the annular part 21b1. The annular part 21a1 of the film 21a and the annular part 21b1 of the film 21b entirely overlap each other. The band-shaped part 21a2 of the film 21a and the band-shaped part 21b2 of the film 21b overlap with each other except at their tip ends.

In the following description, when the strain gauge 2 is seen in a plan view from the front side, a direction in which the band-shaped parts 21a2 and 21b2 extend as viewed from centers of the annular parts 21a1 and 21b1 is defined as a 0 o'clock direction. When the strain gauge 2 is seen in a plan view from the front side, a region of the annular parts 21a1 and 21b1 located in the 0 o'clock direction will be referred to as a “region N,” a region of the annular parts 21a1 and 21b1 located in a 3 o'clock direction will be referred to as a “region E,” a region of the annular parts 21a1 and 21b1 located in a 6 o'clock direction will be referred to as a “region S,” and a region of the annular parts 21a1 and 21b1 located in a 9 o'clock direction will be referred to as a “region W”. Meanwhile, a region of the band-shaped parts 21a2 and 21b2 located at ends opposite to ends closer to the annular parts 21a1 and 21b1 will be referred to as a “region N′”.

As shown in FIG. 4, the front surface of the film 21a is provided with two or more pairs of (in the present embodiment, four pairs, i.e., eight in total) strain-sensitive elements 22a, the wirings 23a, and the electrode pads 24a which are formed thereon by film deposition. One end of each wiring 23a is connected with its corresponding strain-sensitive element 22a, and the other end of the wiring 23a is connected with its corresponding electrode pad 24a. Each strain-sensitive element 22a is connected with two wirings 23a. Thus, on the front surface of the film 21a, the wirings 23a and the electrode pads 24a whose numbers are twice the number of the strain-sensitive elements 22a are formed by film deposition. Each strain-sensitive element 22a is a band-shaped conductor having a resistance which is likely to change according to strain. A material of the strain-sensitive element 22a may be a chromium nitride, for example. However, this is not limitative. Each of the wirings 23a is a band-shaped conductor having a resistance which hardly changes according to strain. Each electrode pad 24a is a quadrangular conductor having a resistance which hardly changes according to strain. Materials of the wirings 23a and the electrode pad 24a may be copper, for example. However, this is not limitative.

In the present embodiment, the front surface of the film 21a is provided with four strain-sensitive elements 22a formed thereon by film deposition. Of the four strain-sensitive elements 22a, two strain-sensitive elements 22a are arranged in the region E, and the remaining two strain-sensitive elements 22a are arranged in the region W. Each of the strain-sensitive elements 22a is connected with two wirings 23a. Thus, the two strain-sensitive elements 22a arranged in the region E are connected with a total of four wirings 23a. These four wirings 23a extend from the region E to the region N through a quarter-arc-shaped path defined in the annular part 21a1, and further extend from the region N to the region N′ through a linear path defined in the band-shaped part 21a2. Tip ends of the four wirings 23a are connected with the electrode pads 24a arranged in the region N′. Similarly, the two strain-sensitive elements 22a arranged in the region W are connected with a total of four wirings 23a. These four wirings 23a extend from the region W to the region N through a quarter-arc-shaped path defined in the annular part 21a1, and further extend from the region N to the region N′ through a linear path defined in the band-shaped part 21a2. Tip ends of the four wirings 23a are connected with the electrode pads 24a arranged in the region N′.

As shown in FIG. 6, the front surface of the film 21a may be provided with the protective film 25a formed thereon by film deposition, the protective film 25a covering the strain-sensitive elements 22a and the wirings 23a. Examples of the protective film 25a encompass a cover film thermally laminated onto the film 21a. However, this is not limitative. Note that the protective film 25a is preferably formed by film deposition so as not to cover the electrode pads 24a.

As shown in FIG. 5, the back surface of the film 21b is provided with two or more pairs of (in the present embodiment, four pairs, i.e., eight in total) other strain-sensitive elements 22b, the other wirings 23b, and the electrode pads 24b which are formed thereon by film deposition. One end of each wiring 23b is connected with its corresponding strain-sensitive element 22b, and the other end of the wiring 23b is connected with its corresponding electrode pad 24b. Each strain-sensitive element 22b is connected with two wirings 23b. Thus, on the back surface of the film 21b, the wirings 23b and the electrode pads 24b whose numbers are twice the number of the strain-sensitive elements 22b are formed by film deposition. Each strain-sensitive element 22b is a band-shaped conductor having a resistance which is likely to change according to strain. A material of the strain-sensitive element 22b may be a chromium nitride, for example. However, this is not limitative. Each of the wirings 23b and the electrode pads 24b is a band-shaped conductor having a resistance which hardly changes according to strain. Materials of the wirings 23b and the electrode pad 24b may be copper, for example. However, this is not limitative.

In the present embodiment, the back surface of the film 21b is provided with four strain-sensitive elements 22b formed thereon by film deposition. Of the four strain-sensitive elements 22b, two strain-sensitive elements 22b are arranged in the region E, and the remaining two strain-sensitive elements 22b are arranged in the region W of the annular part 21b1. Each of the strain-sensitive elements 22b is connected with two wirings 23b. Thus, the two strain-sensitive elements 22b arranged in the region E are connected with a total of four wirings 23b. These four wirings 23b extend from the region E to the region N through a quarter-arc-shaped path defined in the annular part 21b1, and further extend from the region N to the region N′ through a linear path defined in the band-shaped part 21b2. Tip ends of the four wirings 23b are connected with the electrode pads 24a arranged in the region N′. Similarly, the two strain-sensitive elements 22b arranged in the region W are connected with a total of four wirings 23b. These four wirings 23b extend from the region W to the region N through a quarter-arc-shaped path defined in the annular part 21b1, and further extend from the region N to the region N′ through a linear path defined in the band-shaped part 21b2. Tip ends of the four wirings 23b are connected with the electrode pads 24a arranged in the region N′.

As shown in FIG. 6, the back surface of the film 21b may be provided with another protective film 25b formed thereon by film deposition, the another protective film 25b covering the strain-sensitive elements 22b and the wirings 23b. Examples of the another protective film 25b encompass a cover film thermally laminated onto the film 21b. However, this is not limitative. Note that the another protective film 25b is preferably formed by film deposition so as not to cover the electrode pads 24b.

The strain-sensitive elements 22a formed on the front surface of the film 21a by film deposition overlap the other strain-sensitive elements 22b formed on the back surface of the film 21b by film deposition (specifically, the strain-sensitive elements 22a and the other strain-sensitive elements 22b intersect with each other and partially overlap each other), when the film 21 is seen in a plan view. The wirings 23a formed on the front surface of the film 21a by film deposition and the other wirings 23b formed on the back surface of the film 21b by film deposition overlap each other (specifically, the wirings 23a and the other wirings 23b extend in parallel with each other and partially overlap each other), when the film 21a is seen in a plan view. Accordingly, a combination of the strain-sensitive elements 22a and the wirings 23a formed on the front surface of the film 21a by film deposition and a combination of the strain-sensitive elements 22b and the wirings 23b formed on the back surface of the film 21b by film deposition have equivalent performance. That is, it can be expressed that the strain gauge 2 provides redundancy of a circuit for detecting strain which circuit is made of the combination of the strain-sensitive elements 22a and the wirings 23a.

The present embodiment employs a configuration in which a plurality of sets of the strain-sensitive elements 22a and the wirings 23a are formed on the front surface of the film 21a by film deposition. However, the present invention is not limited to this. That is, a single set of the strain-sensitive element 22a and the wiring 23a may alternatively be formed on the front surface of the film 21a by film deposition.

### Method for Producing Strain Gauge

The above-described strain gauge 2 can be produced by, for example, a production including the following steps.
Step 1: A film 21a is produced by laser cutting, into a predetermined shape, a PET film having a back surface adhered to a glass substrate.
Step 2: On a front surface of the film 21a, a copper film functioning as wirings 23a and electrode pads 24a is formed by film deposition.
Step 3: On the front surface of the film 21a, a chromium nitride film functioning as strain-sensitive elements 22a is formed by film deposition. The strain-sensitive elements 22a may be formed by film deposition through silk-screen printing.
Step 4: A cover film functioning as a protective film 25a is thermally laminated onto the front surface of the film 21a. The film 21a on which the strain-sensitive elements 22a, the wirings 23a, the electrode pads 24a, and the protective film 25a are formed is peeled off from the glass substrate.
Step 5: A film 21b is produced by laser cutting, into a predetermined shape, a PET film having a front surface adhered to a glass substrate.
Step 6: On a back surface of the film 21b, a copper film functioning as wirings 23b and electrode pads 24b is formed by film deposition.
Step 7: On the back surface of the film 21b, a chromium nitride film functioning as strain-sensitive elements 22b is formed by film deposition. The strain-sensitive elements 22b may be formed by film deposition through silk-screen printing.
Step 8: A cover film functioning as a protective film 25b is thermally laminated onto the back surface of the film 21b. The film 21b on which the strain-sensitive elements 22b, the wirings 23b, the electrode pads 24b, and the protective film 25b are formed is peeled off from the glass substrate.
Step 9: The back surface of the film 21a having been peeled off from the glass substrate in step 4 is adhered to the front surface of the film 21b having been peeled off from the glass substrate in step 8.

### Application Examples

The above-mentioned strain gauges 1 and 2 are applicable to sensor devices such as a force sensor for detecting force, a torque sensor for detecting torque, and a force/torque sensor for detecting both force and torque.

FIG. 7 is a perspective view illustrating a configuration of a sensor device 100. The sensor device 100 includes a strain body 101 and a strain gauge 102 adhered to the strain body 101. Each of the above-mentioned strain gauges 1 and 2 can be used as a strain gauge 102 of the sensor device 100.

In conventional sensor devices, in order to mount a plurality of strain-sensitive elements onto a strain body, it has been necessary to individually adhere, to the strain body, a plurality of strain gauges each including a single pair of strain-sensitive elements. Consequently, the process of mounting the two or more pairs of strain-sensitive elements onto the strain body requires a long time, and variation is likely to occur in arrangement of the two or more pairs of strain-sensitive elements, disadvantageously. Moreover, in conventional sensor devices, in order to connect two or more pairs of strain-sensitive elements to an amplifier or the like, it has been necessary to individually connect (e.g., via soldering) wirings to the plurality of strain gauges, each including a single pair of strain-sensitive elements. Consequently, the process of connecting the two or more pairs of strain-sensitive elements to the amplifier or the like requires a long time, and arrangement of the connected wirings is likely to become complicated, disadvantageously.

In contrast, in accordance with the sensor device 100, it is possible to mount two or more pairs of strain-sensitive elements to a strain body merely by adhering, to the strain body 101, a single strain gauge 102 having the two or more pairs of strain-sensitive elements formed thereon by film deposition. Consequently, the process of mounting the two or more pairs of strain-sensitive elements onto the strain body does not require a long time, and variation hardly occurs in arrangement of the two or more pairs of strain-sensitive elements. Furthermore, in accordance with the sensor device 100, it is possible to connect two or more pairs of strain-sensitive elements to an amplifier or the like merely by connecting, to the amplifier or the like, a single strain gauge having the two or more pairs of wirings formed thereon by film deposition (e.g., via connector connection). Consequently, the process of connecting the two or more pairs of strain-sensitive elements to the amplifier or the like does not take a long time, and arrangement of the connected wirings hardly becomes complicated.

Aspects of the present invention can also be expressed as follows:

A strain gauge in accordance with a first aspect of the present invention includes: a film; a wiring formed on one main surface of the film by film deposition; and two or more pairs of strain-sensitive elements formed on the one main surface of the film by film deposition, the two or more pairs of strain-sensitive elements being connected with the wiring.

In accordance with the above configuration, it is possible to mount two or more pairs of strain-sensitive elements onto a strain body merely by adhering, to the strain body, a single strain gauge having the two or more pairs of strain-sensitive elements formed thereon by film deposition. Consequently, it is possible to provide a sensor device that does not require a long time to mount two or more pairs of strain-sensitive elements onto a strain body and that hardly causes variation in arrangement of the two or more pairs of strain-sensitive elements thus mounted.

A strain gauge in accordance with a second aspect of the present invention is the strain gauge in accordance with the first aspect, the strain gauge further including: an electrode pad formed on the one main surface by film deposition, the electrode pad being connected with the wiring.

In accordance with the above configuration, it is possible to facilitate the process of connecting the two or more pairs of strain-sensitive elements to an amplifier or the like.

A strain gauge in accordance with a third aspect of the present invention is the strain gauge in accordance with the first or second aspect, the strain gauge further including: a protective film formed on the one main surface by film deposition, the protective film covering the two or more pairs of strain-sensitive elements and the wiring.

In accordance with the above configuration, it is possible to make it difficult to cause a short circuit between the wirings that may be caused by, e.g., contact with an object having electric conductivity. Moreover, it is possible to enhance durability of the strain-sensitive elements and the wirings. Furthermore, it is possible to suppress oxidization of the strain-sensitive elements and the wirings.

A strain gauge in accordance with a fourth aspect of the present invention is the strain gauge in accordance with the first aspect, the strain gauge further including: another wiring formed on the other main surface of the film by film deposition; and two or more pairs of other strain-sensitive elements formed on the other main surface of the film by film deposition, the two or more pairs of other strain-sensitive elements being connected with the another wiring.

In accordance with the above configuration, it is possible to provide the redundancy of the strain-sensitive elements and the wirings. That is, if a failure occurs in the strain-sensitive elements or the wiring formed on the one main surface by film deposition, it is possible to use the other strain-sensitive elements or the another wiring formed on the other main surface by film deposition. Conversely, if a failure occurs in the other strain-sensitive elements or the another wiring formed on the other main surface by film deposition, it is possible to use the strain-sensitive elements or the wiring formed on the one main surface by film deposition. Alternatively, the strain-sensitive elements formed on the one main surface by film deposition and the strain-sensitive elements formed on the other main surface by film deposition can be used as strain-sensitive elements having different biases.

A strain gauge in accordance with a fifth aspect of the present invention is the strain gauge in accordance with the first aspect, the strain gauge further including: another film having one main surface that is adhered to the other main surface of the film; another wiring formed on the other main surface of the another film by film deposition; and two or more pairs of other strain-sensitive elements formed on the other main surface of the another film by film deposition, the two or more pairs of other strain-sensitive elements being connected with the another wiring.

In accordance with the above configuration, it is possible to provide the redundancy of the strain-sensitive elements and the wirings. That is, if a failure occurs in the strain-sensitive elements or the wiring formed on the one film by film deposition, it is possible to use the other strain-sensitive elements or the another wiring formed on the other film by film deposition. Conversely, if a failure occurs in the other strain-sensitive elements or the another wiring formed on the other film by film deposition, it is possible to use the strain-sensitive elements or the wiring formed on the one film by film deposition. Alternatively, the strain-sensitive elements formed on the one film by film deposition and the strain-sensitive elements formed on the other film by film deposition can be used as strain-sensitive elements having different biases.

A method, in accordance with a sixth aspect of the present invention, for producing a strain gauge includes the steps of: forming a wiring on one main surface of a film by film deposition; and forming two or more pairs of strain-sensitive elements on the one main surface of the film by film deposition, the two or more pairs of strain-sensitive elements being connected with the wiring.

In accordance with the above configuration, it is possible to mount two or more pairs of strain-sensitive elements onto a strain body merely by adhering, to the strain body, a single strain gauge having the two or more pairs of strain-sensitive elements formed thereon by film deposition. Consequently, it is possible to produce a sensor device that does not require a long time to mount two or more pairs of strain-sensitive elements onto a strain body and that hardly causes variation in arrangement of the two or more pairs of strain-sensitive elements thus mounted.

A method in accordance with a seventh aspect of the present invention is the method in accordance with the sixth aspect further including the steps of: forming another wiring on the other main surface of the film by film deposition; and forming two or more pairs of other strain-sensitive elements on the other main surface of the film by film deposition, the two or more pairs of other strain-sensitive elements being connected with the another wiring.

In accordance with the above configuration, it is possible to produce a strain gauge in which redundancy of strain-sensitive elements and wiring is provided or a strain gauge in which strain-sensitive elements having different biases are formed.

A method in accordance with an eighth aspect of the present invention is the method in accordance with the sixth aspect further including the steps of: forming, by film deposition, another wiring on another film, which has one main surface and the other main surface, such that the another film is formed on the other main surface; forming two or more pairs of other strain-sensitive elements on the other main surface of the another film by film deposition, the two or more pairs of other strain-sensitive elements being connected with the another wiring; and adhering the other main surface of the film to the one main surface of the another film.

In accordance with the above configuration, it is possible to produce a strain gauge in which redundancy of strain-sensitive elements and a wiring is provided or a strain gauge in which strain-sensitive elements having different biases are formed.

A sensor device in accordance with a ninth aspect of the present invention includes: a strain gauge described in any one of the first to fifth aspects; and a strain body having the strain gauge adhered thereto.

In accordance with the above configuration, it is possible to mount two or more pairs of strain-sensitive elements onto a strain body merely by adhering, to the strain body, a single strain gauge having the two or more pairs of strain-sensitive elements formed thereon by film deposition. Consequently, it is possible to provide a sensor device that does not require a long time to mount two or more pairs of strain-sensitive elements onto a strain body and that hardly causes variation in arrangement of the two or more pairs of strain-sensitive elements thus mounted.

A strain gauge in accordance with a tenth aspect of the present invention is the strain gauge in accordance with the fourth or fifth aspect, wherein: the two or more pairs of strain-sensitive elements and the two or more pairs of other strain-sensitive elements are arranged so as to partially or entirely overlap each other as the strain gauge is seen in a plan view; and the wiring and the another wiring are arranged so as to partially or entirely overlap each other as the strain gauge is seen in a plan view.

The above configuration can match (i) the characteristics of a circuit including the two or more pairs of strain-sensitive elements and the wiring to (ii) those of a circuit including the two or more pairs of other strain-sensitive elements and the another wiring. This can suppress variations in the characteristics that may occur when the strain-sensitive elements and the wiring to be used are switched to different ones.

1. A strain gauge comprising:
a film;
a wiring formed on one main surface of the film by film deposition; and
two or more pairs of strain-sensitive elements formed on the one main surface of the film by film deposition, the two or more pairs of strain-sensitive elements being connected with the wiring.

2. The strain gauge according to claim 1, further comprising:
an electrode pad formed on the one main surface by film deposition, the electrode pad being connected with the wiring.

3. The strain gauge according to claim 1, further comprising:
a protective film formed on the one main surface by film deposition, the protective film covering the two or more pairs of strain-sensitive elements and the wiring.

4. The strain gauge according to claim 1, further comprising:
another wiring formed on the other main surface of the film by film deposition; and
two or more pairs of other strain-sensitive elements formed on the other main surface of the film by film deposition, the two or more pairs of other strain-sensitive elements being connected with the another wiring.

5. The strain gauge according to claim 1, further comprising:
another film having one main surface that is adhered to the other main surface of the film;
another wiring formed on the other main surface of the another film by film deposition; and
two or more pairs of other strain-sensitive elements formed on the other main surface of the another film by film deposition, the two or more pairs of other strain-sensitive elements being connected with the another wiring.

6. A method for producing a strain gauge, comprising the steps of:
forming a wiring on one main surface of a film by film deposition; and
forming two or more pairs of strain-sensitive elements on the one main surface of the film by film deposition, the two or more pairs of strain-sensitive elements being connected with the wiring.

7. The method according to claim 6, further comprising the steps of:
forming another wiring on the other main surface of the film by film deposition; and
forming two or more pairs of other strain-sensitive elements on the other main surface of the film by film deposition, the two or more pairs of other strain-sensitive elements being connected with the another wiring.

8. The method according to claim 6, further comprising the steps of:
forming, by film deposition, another wiring on another film, which has one main surface and the other main surface, such that the another film is formed on the other main surface;
forming two or more pairs of other strain-sensitive elements on the other main surface of the another film by film deposition, the two or more pairs of other strain-sensitive elements being connected with the another wiring; and
adhering the other main surface of the film to the one main surface of the another film.

9. A sensor device comprising:
a strain gauge recited in claim 1; and
a strain body having the strain gauge adhered thereto.
